(19) United States
(12) Patent Application Publication
(10) Pub. No.: US 2013/0249779 A1
(43) Pub. Date: Sep. 26, 2013

(54) DISPLAY DEVICE AND ELECTRONIC APPARATUS

(71) Applicant: JAPAN DISPLAY WEST INC., AICHI-KEN (JP)

(72) Inventors: Tsutomu Harada, Kanagawa (JP); Soichiro Kurokawa, Kanagawa (JP); Takayuki Nakanishi, Kanagawa (JP); Naoyuki Takasaki, Kanagawa (JP)

(73) Assignee: JAPAN DISPLAY WEST INC., AICHI-KEN (JP)

(21) Appl. No.: 13/751,636

(22) Filed: Jan. 28, 2013

(30) Foreign Application Priority Data
Mar. 22, 2012 (JP) 2012-064640

(51) Int. Cl. G09G 3/36

(52) U.S. Cl. CPC G09G 3/36
USPC 345/88; 345/98

(57) ABSTRACT

A display device includes: an update area detecting unit that detects a rewritten area on the basis of first image data previously transmitted and second image data newly transmitted and that sends out only a part of the second image data in the rewritten area to a display panel which includes a memory that stores image data or a cell having a memory effect in each pixel.

### CROSS REFERENCES TO RELATED APPLICATIONS

The present application claims priority to Japanese Priority Patent Application JP 2012-064640 filed in the Japan Patent Office on Mar. 22, 2012, the entire content of which is hereby incorporated by reference.

### BACKGROUND

The present disclosure relates to a display device and an electronic apparatus, and more particularly, to a display device having a memory, which stores image data, built into each pixel of a liquid crystal and realizing a further decrease in power consumption and an electronic apparatus having the display device.

Currently, various types of devices exist as a device displaying an image. Most thereof do not retain an image, but the image display often disappears without continuously writing the image.

For example, in a liquid crystal display device, it is necessary to drive a liquid crystal in an alternating manner. Accordingly, even when a still image is displayed, pixel data is continuously written with a cycle of about 60 Hz. As another reason, since a storage capacitor (capacitor) storing pixel data exists in each pixel but a path through which current leaks from the storage capacitor is present, it is necessary to update pixel data within a predetermined time. The problem with leakage is not limited to the liquid crystal display device, and is true in an organic EL (Electro-Luminescence) display device and a plasma display device.

When image data is continuously written to pixels, lines connected to the pixels are constantly driven and unnecessary power for charging and discharging the lines is consumed. When the number of pixels of a display device increases, the writing power increases in proportion thereto. When the area of a display device increases, the signal lines to the pixels are lengthened by as much and it is necessary to increase driving power.

If image data has to be continuously transmitted to a display device, it means that transmission power to the display device is consumed. Accordingly, this display device is disadvantageous for applications in which a still image is displayed for a long period of time, such as electronic books, in terms of power consumption.

On the other hand, several types of devices called electronic paper are known as a display device which does not cause an image display to disappear (which has a memory effect) without continuously writing an image. Since the materials of such display devices retain a display, it is not necessary to perform a rewriting operation of retaining a still image, unlike a liquid crystal display device, and such display devices are superior from the viewpoint of electronic books specialized for displaying a still image, because the power consumption is small. However, when a display image is rewritten, a high voltage is generally necessary for electronic paper and thus a large amount of power is consumed therein. In addition, the time taken to rewrite the display device is 100 msec or more. Accordingly, since only images of less than 10 frames per second can be rewritten, the electronic paper is not able to display a moving image, in which it is necessary to write 30 or more frames per second. In recent Internet pictures, an advertisement of a moving image may be put in a part of the picture or a small window of a moving image may be opened. However, the electronic paper is not able to rewrite a part of a display image.

On the contrary, a technique is known which has solved the problem with charging and discharging power consumption due to the AC driving operation of a liquid crystal and the problem with power consumption by transmitting pixel data to pixels of the liquid crystal, for example, even in displaying a still image at a high speed (for example, see JP-A-2010-145663). In this technique, an SRAM (Static Random Access Memory) type or a DRAM (Dynamic Random Access Memory) type memory is provided to each pixel so as to store pixel data. Accordingly, when displaying a still image, it is possible to directly write pixel data to the memories and it is not necessary to transmit the pixel data to the memories. In the case of a liquid crystal display device, since a circuit performing an inverse driving operation is provided, an AC inverse driving operation can be performed in the units of pixels and it is not necessary to charge and discharge signal lines having a large capacitive load, thereby greatly reducing power even for displaying a still image.

### SUMMARY

However, the display device having a memory built into each pixel is effective in a decrease in power consumption for displaying a still image, but is not effective in a decrease in power consumption for displaying a partially-updated image or a still image partially including a moving image.

It is therefore desirable to provide a display device and an electronic apparatus which can reduce power consumption even for a partially-rewritten image.

An embodiment of the present disclosure is directed to a display device including: an update area detecting unit that detects a rewritten area on the basis of first image data previously transmitted and second image data newly transmitted and that sends out only a part of the second image data in the rewritten area to a display panel which includes a memory that stores image data or a cell having a memory effect in each pixel.

Another embodiment of the present disclosure is directed to an electronic apparatus having a display device including: an update area detecting unit that detects a rewritten area on the basis of first image data previously transmitted and second image data newly transmitted and that sends out only a part of the second image data in the rewritten area to a display panel which includes a memory that stores image data or a cell having a memory effect in each pixel.

According to the display device and the electronic apparatus of the embodiments of the present disclosure, it is possible to reduce power consumption even for a partially-rewritten image.

Additional features and advantages are described herein, and will be apparent from the following Detailed Description and the figures.

### BRIEF DESCRIPTION OF THE FIGURES

FIG. 1 is a block diagram illustrating the configuration of a display device according to an embodiment;

FIG. 2 is a block diagram illustrating an example of the configuration of an update area detecting unit of a display device according to a first embodiment;

FIG. 3 is a block diagram illustrating an example of the configuration of an update area detecting unit of a display device according to a second embodiment;

FIG. 4 is a block diagram illustrating an example of the configuration of an update area detecting unit of a display device according to a third embodiment;

FIG. 5 is a diagram illustrating blocks set for a screen of the display device according to the third embodiment;

FIG. 6 is a diagram illustrating an example where the update area detecting unit is applied to a driver IC of a liquid crystal display panel; and

FIG. 7 is a perspective view illustrating the appearance of a television set to which the present disclosure is applied.

### DETAILED DESCRIPTION

Hereinafter, embodiments of the present disclosure will be described in detail with reference to the accompanying drawings.

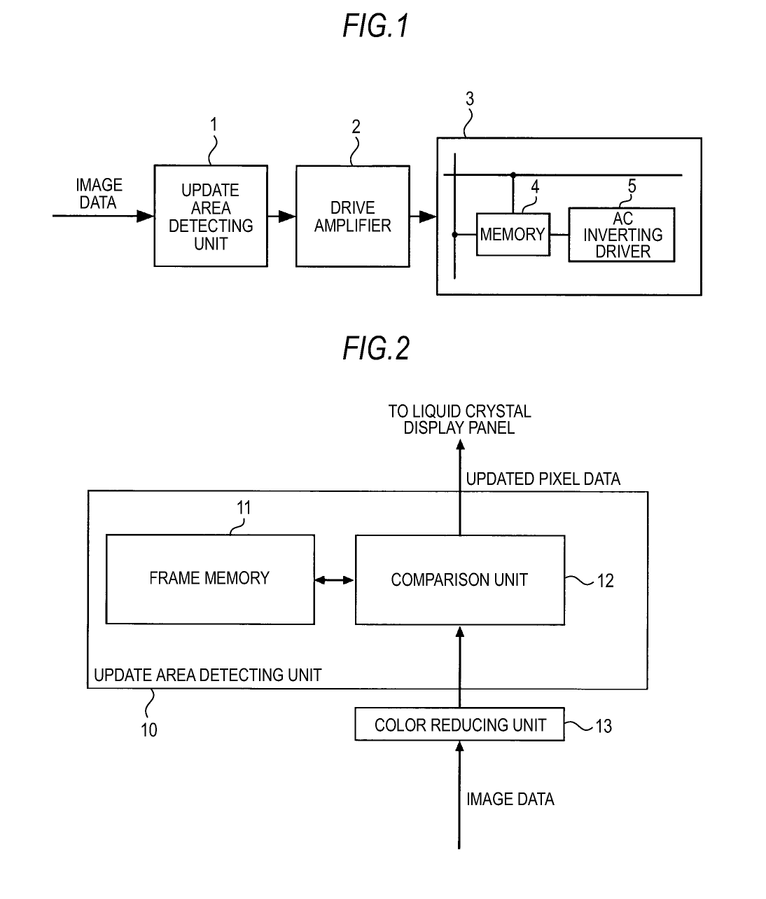

FIG. 1 is a block diagram illustrating the configuration of a display device according to an embodiment.

A display device includes an update area detecting unit 1, a drive amplifier 2, and a liquid crystal display panel 3. Here, the liquid crystal display panel 3 includes a memory 4 (or a cell having a memory effect) storing pixel data for controlling a display of a liquid crystal and an AC inverting driver 5 for each pixel (where only one pixel is shown in the drawing). The memory 4 and the AC inverting driver 5 are monolithically formed using thin film transistors below a liquid crystal pixel constituting an image display unit and the memory 4 is formed in an SRAM or DRAM type.

The liquid crystal display panel 3 having the memory 4 for each pixel in this way is connected to be driven by the drive amplifier 2 and the drive amplifier 2 is connected to receive image data transmitted from the update area detecting unit 1.

The update area detecting unit 1 detects a rewritten area of presently-transmitted image data relative to image data of a previous frame and transmits data of only the rewritten area (update area) to the drive amplifier 2. The drive amplifier 2 transmits the data of only the update area to the corresponding pixels. In the liquid crystal display panel 3, a non-rewritten pixel performs a display operation on the basis of data stored in the memory 4, and a pixel to be updated stores the transmitted data in the memory 4 and performs a display operation based on the data.

It is determined whether transmitted image data is partially rewritten, and when it is determined that a rewritten area exists, the drive amplifier 2 transmits only data of the area to the liquid crystal display panel 3. Accordingly, it is possible to greatly reduce the power consumption necessary for data transmission.

The configuration of the update area detecting unit 1 will be specifically described below for each update area.

FIG. 2 is a block diagram illustrating an example of the configuration of an update area detecting unit of the display device according to a first embodiment.

The update area detecting unit 10 of the display device according to the first embodiment includes a frame memory 11 having memory capacity corresponding to a frame and a comparison unit 12 detecting updated pixels. A color reducing unit 13 is disposed at the input stage of the update area detecting unit 10. The update area detecting unit 10 temporarily stores the transmitted image data in the frame memory 11, and the comparison unit 12 compares the transmitted image data with image data in the frame memory 11 and outputs only data of updated pixels to the liquid crystal display panel 3.

Before the update area detecting unit 10 detects an update area from the transmitted image data, the color reducing unit 13 first performs a color reducing process on the image data. This is because the gray scale which can be expressed by pixels is often limited (about 1 bit to 3 bits in most cases) in such a type of liquid crystal display panel 3 in which a memory 4 storing image data is built in each pixel of the liquid crystal. That is, the memory 4 which is, for example, an SRAM type has to include six transistors per bit. On the other hand, when it is intended to display full colors, it is necessary to construct each of red, blue, and green pixels into 8 bits (256 gray scales). Since it is difficult to mount plural transistors corresponding to 6 bits on each pixel from the viewpoint of manufacturing, it is necessary to reduce colors of the original image. Here, since the memory 4 is constructed in 2 bits for each of red, blue, and green, that is, in 6 bits in total, the color reducing unit 13 performs a process of reducing 16777216 colors expressed by 24 bits to 64 colors which can be expressed by 6 bits. The method of the color reducing process can employ several established techniques such as an error diffusion method.

The image data having been subjected to the color reducing process by the color reducing unit 13 is reduced from 24 bits in the original to 6 bits as color information. Accordingly, the frame memory 11 has memory capacity corresponding to a frame with 6 bits per pixel.

At the first time, the comparison unit 12 writes the image data of a frame having been subjected to the color reducing process by the color reducing unit 13 to the frame memory 11 and also transmits the image data to the liquid crystal display panel 3. The liquid crystal display panel 3 receiving the image data displays pixel data of the image data for each pixel and stores the pixel data in the memories 4.

In the subsequent frame period, the comparison unit 12 sequentially compares the pixel data output from the color reducing unit 13 with pixel data read from the frame memory 11 and having the same display address, and determines whether both sets of data are matched with each other.

When it is determined that both sets of data are matched with each other, the corresponding pixel is determined to be a pixel constituting a still image and the comparison unit 12 does not perform any process on the pixel. That is, the comparison unit 12 does not transmit any signal to the liquid crystal display panel 3. At this time, a display based on the pixel data stored in the memory 4 is retained in the corresponding pixel of the liquid crystal display panel 3.

On the other hand, when it is determined that both sets of data are not matched with each other, the pixel is determined to be a pixel constituting a moving image and the comparison unit 12 writes the pixel data output from the color reducing unit 13 to the frame memory 11 to update the frame memory and transmits the pixel data as updated pixel data to the liquid crystal display panel 3. In the corresponding pixel of the liquid crystal display panel 3, the display of the corresponding pixel is updated with the updated pixel data and the data of the memory 4 is also updated.

In this way, since the update area detecting unit 10 transmits only the pixel data determined to constitute a moving image as updated pixel data to the liquid crystal display panel 3 and does not transmit the pixel data determined to constitute a still image, it is possible to reduce the power consumption by as much. Since the update area detecting unit 10 compares the pixels with each other, the pixel data used for the comparison can be used as updated pixel data to be transmitted to the liquid crystal display panel 3.

As described above, the update area detecting unit 10 can reduce the power consumption for an image in which a still image and a moving image are mixed and can further reduce the power consumption for an image including more still images.

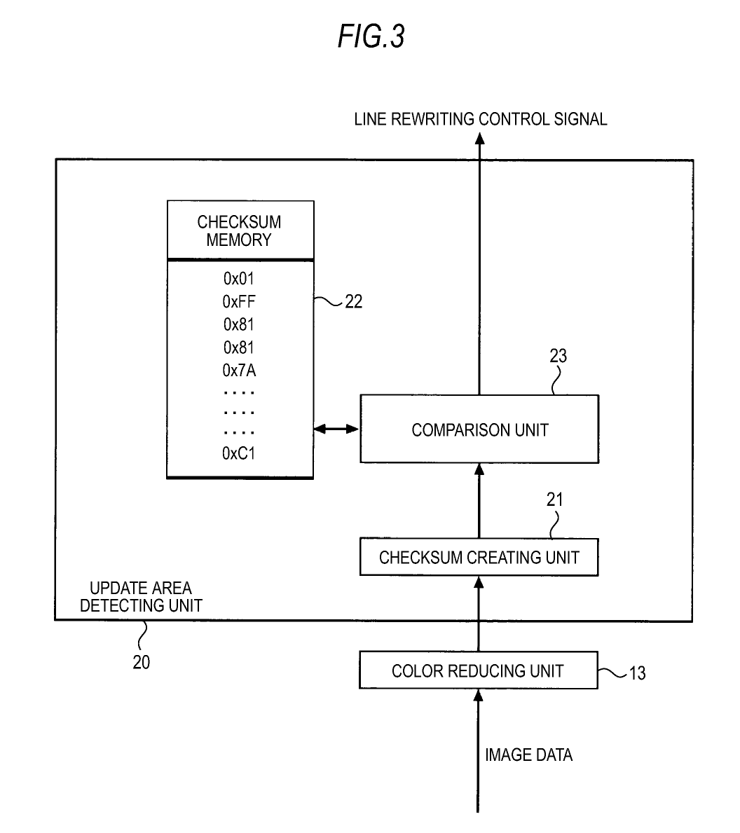

FIG. 3 is a block diagram illustrating an example of the configuration of an update area detecting unit of a display device according to a second embodiment.

Regarding detection of an update area, the update area detecting unit 10 of the display device according to the first embodiment compares the pixels with each other, but the update area detecting unit 20 of the display device according to the second embodiment compares lines of pixels with each other. The update area detecting unit 20 is suitable for used in such a type of line-sequential driving liquid crystal display panel in which pixels are scanned in the horizontal direction and data is sequentially written from the upside.

The update area detecting unit 20 includes a checksum creating unit 21 creating a checksum of pixel data for each line, a checksum memory 22 storing the created checksum, and a comparison unit 23 comparing the checksums with each other.

The checksum creating unit 21 serves to add the values of pixel data of a line and to output the sum and calculates the checksum for each line. The checksum memory 22 serves to store the checksum created by the checksum creating unit 21 and has a storage area corresponding to the number of lines of a frame.

The comparison unit 23 first writes the checksum of a line created by the checksum creating unit 21 to the checksum memory 22 and also transmits a line rewriting control signal to the liquid crystal display panel 3. The liquid crystal display panel 3 receiving the line rewriting control signal displays pixel data of image data for each line and stores the pixel data in the memories 4. This series of operations are performed until the first frame is completely processed.

In the subsequent period of frame, the comparison unit 23 compares the checksum of the same line read from the checksum memory 22 with the checksum created by the checksum creating unit 21, and determines whether both checksums are matched with each other.

When it is determined that both checksums are matched with each other, the line is determined to be a line constituting a still image and the comparison unit 23 does not perform any process on the line. That is, the comparison unit 23 does not transmit the line rewriting control signal to the liquid crystal display panel 3. At this time, the pixels of the corresponding line in the liquid crystal display panel 3 retain a display on the basis of the pixel data stored in the memories 4.

On the other hand, when both checksums are not matched with each other due to inclusion of any pixel of a moving image in the corresponding line or the like, the line as a whole is determined to constitute a moving image. At this time, the comparison unit 23 writes the checksum created by the checksum creating unit 21 to the checksum memory 22 to update the checksum, and transmits the line rewriting control signal to the liquid crystal display panel 3. In the corresponding line of the liquid crystal display panel 3, the display of the corresponding pixels is updated on the basis of the updated pixel data and the data of the memories 4 are also updated.

In this way, in the update area detecting unit 20, only a line including pixel data determined to constitute a moving image is determined to be a rewriting target of pixel data, and a line including pixel data determined to constitute a still image is determined to be other than a rewriting target of pixel data. Accordingly, in the lines other than a rewriting target of pixel data, the line rewriting control signal is not transmitted to the liquid crystal display panel 3 and the rewriting is not performed, thereby reducing the power consumption.

In the update area detecting unit 20, the capacity of the checksum memory 22 as a memory storing data of pixel data of the previous frames can be still more reduced than the capacity of the frame memory 11 and thus the circuit scale can be reduce by as much.

In the comparison of the checksums calculated for each line, for example, in the case of a moving image in which an object moves in the line direction against the background of a wall of the same color, the width in the line direction of the object is not changed and thus the line may be erroneously recognized as a line of a still image. In this case, for example, by multiplying the pixel values by the values of display addresses in the horizontal direction and simply adding the resultant values, the checksum can be created.

When the pixel values are multiplied by the values of display addresses, for example, in a liquid crystal display panel 3 with a high resolution in the horizontal direction of the display screen, the number of bits of the checksum becomes very large and thus the checksum memory 22 also has to have large capacity. In this case, for example, by using only several lower bits of the necessary number of bits for the checksum, it is possible to reduce the data amount of the checksum.

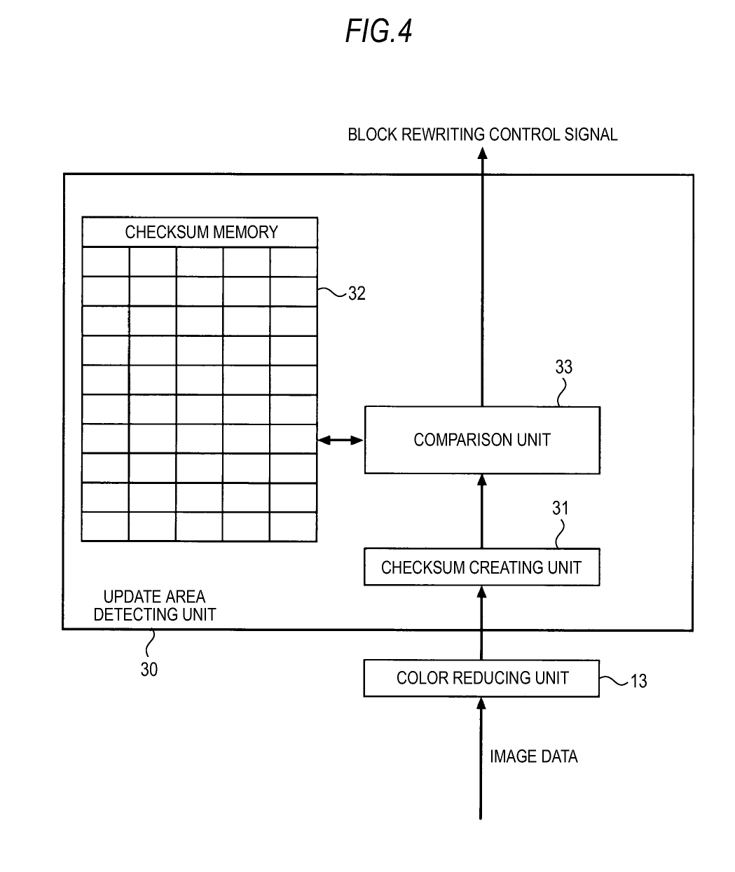

FIG. 4 is a block diagram illustrating an example of the configuration of an update area detecting unit of a display device according to a third embodiment.

Regarding detection of an update area, the update area detecting unit 20 of the display device according to the second embodiment compares the lines of pixels with each other, but the update area detecting unit 30 of the display device according to the third embodiment compares blocks of pixels with each other. A block means a small defined area including plural lines and plural columns adjacent to each other. As the number of lines and the number of columns constituting a block become smaller, the detection accuracy of an update area can become higher. In a line-sequential driving liquid crystal display panel, the number of lines can be reduced up to 1.

The update area detecting unit 30 includes a checksum creating unit 31 creating a checksum of pixel data for each block, a checksum memory 32 storing the created checksum, and a comparison unit 33 comparing the checksums with each other.

The checksum creating unit 31 serves to add the values of pixel data of a block and to output the sum and calculates the checksum for each block. The checksum memory 32 serves to store the checksum created by the checksum creating unit 31 and has a storage area corresponding to the number of blocks of a frame.

The comparison unit 33 first writes the checksum of a block created by the checksum creating unit 31 to the checksum memory 32 and also transmits a block rewriting control signal to the liquid crystal display panel 3. The liquid crystal display panel 3 receiving the block rewriting control signal displays pixel data of image data for each block and stores the pixel data in the memories 4. This series of operations are performed until the first frame is completely processed.

In the subsequent period of frame, the comparison unit 33 compares the checksum of the same block read from the checksum memory 32 with the checksum created by the checksum creating unit 31, and determines whether both checksums are matched with each other.

When it is determined that both checksums are matched with each other, the block is determined to be a block constituting a still image and the comparison unit 33 does not perform any process on the block. That is, the comparison unit 33 does not transmit the block rewriting control signal to the liquid crystal display panel 3. At this time, the pixels of the corresponding block in the liquid crystal display panel 3 retain a display on the basis of the pixel data stored in the memories 4.

On the other hand, when both checksums are not matched with each other due to inclusion of any pixel of a moving image in the corresponding block or the like, the block as a whole is determined to constitute a moving image. At this time, the comparison unit 33 writes the checksum created by the checksum creating unit 31 to the checksum memory 32 to update the checksum, and transmits the block rewriting control signal to the liquid crystal display panel 3. In the corresponding block of the liquid crystal display panel 3, the display of the corresponding pixels is updated on the basis of the updated pixel data and the data of the memories 4 are also updated.

In this way, in the update area detecting unit 30, only a block including pixel data determined to constitute a moving image is determined to be a rewriting target of pixel data, and a block including pixel data determined to constitute a still image is determined to be other than a rewriting target of pixel data. Accordingly, in the blocks other than a rewriting target of pixel data, the block rewriting control signal is not transmitted to the liquid crystal display panel 3 and the rewriting is not performed, thereby reducing the power consumption.

In the comparison of the checksums calculated for each block, for example, in the case of a moving image in which a figure having a fixed size moves in a block against the background of a wall of the same color, the values of the checksums are equal to each other and thus the block may be erroneously recognized as a block of a still image. In this case, for example, by multiplying the pixel values by the values of display addresses in the vertical and horizontal direction and simply adding the resultant values, the checksum can be created. By using the values of the addresses assigned to only the block, it is possible to cause the number of bits of the checksum to be smaller than the values of the addresses indicating the entire screen and thus to reduce the data amount of the checksums.

Nevertheless, when the number of bits of the checksums becomes large, it is possible to further reduce the data amount of the checksum, for example, by using only several lower bits of the necessary number of bits for the checksums. On the contrary, the probability of erroneous detection becomes high. The probability of erroneous detection will be described below.

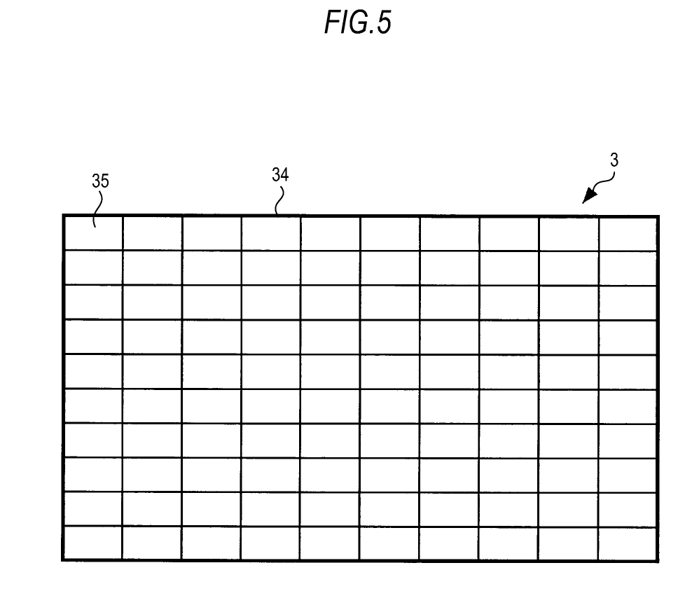

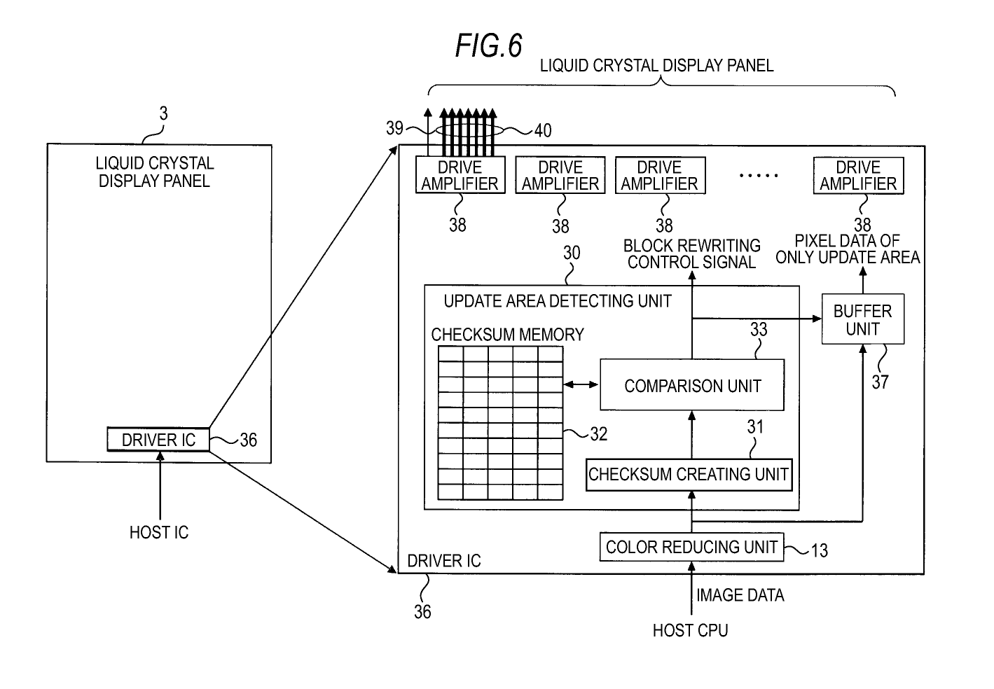

FIG. 5 is a diagram illustrating blocks set for a screen of the display device according to the third embodiment.

In the example shown in the drawing, the screen 34 of the liquid crystal display panel 3 is vertically and horizontally divided into 10 parts to set 100 blocks 35. Here, the probability of erroneous detection of each block 35 is calculated on the basis of the number of bits of the checksum, and the probability of erroneous detection in the entire screen can be estimated by multiplying the resultant number of bits of the checksum by the number of blocks 35.

For example, when the number of bits of the checksum is 12 bits for each area, the probability of erroneous detection of the area is 1/4096. Since 100 areas are present in FIG. 5, the probability of erroneous detection of the entire screen 34 is 100/4096=0.02.

When erroneous detection is caused and a block to be determined as a still image is erroneously determined to be a moving image, the same pixel data is overwritten and thus there is no problem. However, when a block to be determined as a moving image is erroneously determined to be a still image, the image is not updated and thus the motion of the moving image is not natural.

For example, when a moving image of 30 frames per second is displayed in an area of about 1/10 of the overall area of the screen, the probability of erroneous detection of a frame is 10/4096=0.002. When this value is converted into a frequency, one erroneous detection occurs per about 400 frames (13.7 seconds), which is an inconspicuous level.

On the other hand, in the case of a moving image occupying the entire screen with 60 frames per second, the update is not performed at the probability of 100/4096, which means that the update may not be performed in one block out of 40 frames.

In this case, the number of bits of the checksums is preferably set to be still more. For example, in the checksum of 20 bits, the probability is 100/2̂20=9.5e−5 and the frequency at which the update is not erroneously performed is one per 175 seconds, that is, one per about 2 minutes, which is a sufficient inconspicuous level.

FIG. 6 is a diagram illustrating an example where the update area detecting unit is applied to a driver IC of a liquid crystal display panel.

The liquid crystal display panel 3 includes a driver IC (Integrated Circuit) 36. The driver IC 36 has a function of receiving image data sent from a host IC and outputting a signal for driving a display cell.

The driver IC 36 includes a color reducing unit 13, an update area detecting unit 30, a buffer unit 37, and plural drive amplifiers 38. The update area detecting unit 30 is the same as shown in FIG. 4. The buffer unit 37 temporarily stores pixel data of one block having been subjected to a color reducing process by the color reducing unit 13 and outputs the stored pixel data when the update area detecting unit 30 detects the update of the block. The drive amplifiers 38 corresponding to, for example, the number of blocks (10 in FIG. 5) in the horizontal direction of the liquid crystal display panel 3 are provided and each drive amplifier includes a control line 39 for outputting a block rewriting control signal and a signal line 40 for outputting pixel data.

According to the driver IC 36 having the above-mentioned configuration, when image data is sent from a host CPU processing image data, the image data is first appropriately subjected to a color reducing process by the color reducing unit 13. The image data subjected to the color reducing process is stored in the buffer unit 37 and is input to the checksum creating unit 31 of the update area detecting unit 30. The checksum creating unit 31 creates the checksum of the image data subjected to the color reducing process and transmits the created checksum to the comparison unit 33. The comparison unit 33 reads the checksum of the corresponding block from the checksum memory 32 and compares the checksum read from the checksum memory 32 with the newly created checksum.

When both checksums are not matched with each other as the comparison result, the comparison unit 33 transmits a block rewriting control signal to the drive amplifier 38 corresponding to the block and updates the checksum corresponding to the block in the checksum memory 32 with the created checksum. At the same time, the comparison unit 33 transmits the pixel data stored in the buffer unit 37 to the same drive amplifier 38. Accordingly, the drive amplifier 38 transmits the block rewriting control signal via the control line 39 and transmits the updated pixel data via the signal line 40.

When both checksums are matched with each other, it is not necessary to perform a rewriting operation on the block and thus the block rewriting control signal and the pixel data are not transmitted from the drive amplifier 38. At this time, the memory 4 of the non-rewritten pixel retains the pixel data.

Accordingly, pixel data is rewritten to only the updated area in the image, thereby implementing a display with the minimum rewriting power.

A specific example of an electronic apparatus to which the present disclosure is applied will be described below.

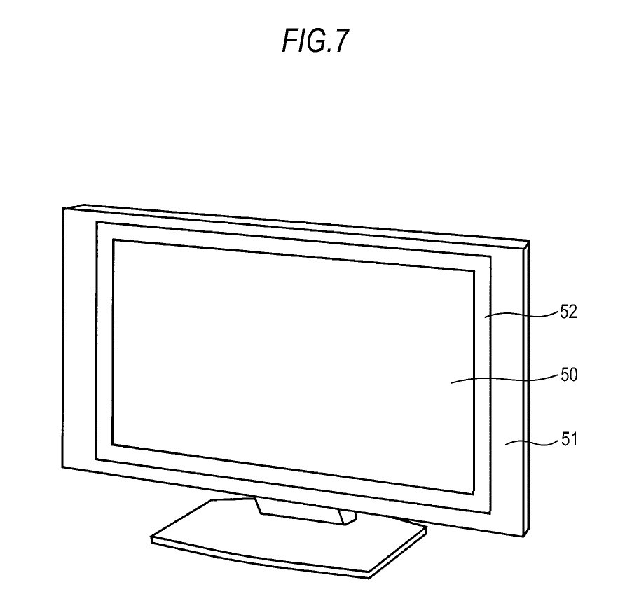

FIG. 7 is a perspective view illustrating the appearance of a television set to which the present disclose is applied.

The television set according to this application example includes an image display screen unit 50 including a front panel 51 and a filter glass 52. The display device according to the embodiments of the present disclosure is used as the image display screen unit 50.

In the above-mentioned embodiments, the function of detecting an update area is provided to the side receiving and displaying image data, but may be provided to a video processor side of a host device transmitting image data.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device comprising:
an update area detecting unit that detects a rewritten area on the basis of first image data previously transmitted and second image data newly transmitted and that sends out only a part of the second image data in the rewritten area to a display panel which includes a memory that stores image data or a cell having a memory effect in each pixel.

2. The display device according to claim 1, wherein the update area detecting unit includes:
a memory unit that retains the first image data for each line; and
a comparison unit that compares the first image data stored in the memory unit with the second image data for each line and that writes the second image data to the memory unit for each line to update the first image data stored in the memory unit when both sets of image data are not matched with each other.

3. The display device according to claim 2, further comprising a checksum creating unit that calculates a checksum of pixel values for each line,
wherein the memory unit stores a first checksum for each line of the first image data instead of the first image data, and
wherein the comparison unit detects a rewritten line area by comparing a second checksum for each line of the second image with the first checksum.

4. The display device according to claim 3, wherein the checksum is a total sum of values obtained by multiplying the pixel values by address values.

5. The display device according to claim 4, wherein only several lower bits of the necessary number of bits are used for the checksum.

6. The display device according to claim 1, wherein the update area detecting unit includes:
a memory unit that retains the first image data for each block which is set by dividing the screen of the display panel into a plurality of blocks; and
a comparison unit that compares the first image data stored in the memory unit with the second image data for each block and that writes the second image data to the memory unit for each block to update the first image data stored in the memory unit when both sets of image data are not matched with each other.

7. The display device according to claim 6, further comprising a checksum creating unit that calculates a checksum of pixel values for each block,
wherein the memory unit stores a first checksum for each block of the first image data instead of the first image data, and
wherein the comparison unit detects a rewritten block area by comparing a second checksum for each block of the second image with the first checksum.

8. The display device according to claim 7, wherein the checksum is a total sum of values obtained by multiplying the pixel values by address values.

9. The display device according to claim 8, wherein only several lower bits of the necessary number of bits are used for the checksum.

10. The display device according to claim 1, wherein the update area detecting unit includes:
a memory unit that retains pixel data corresponding to a frame; and
a comparison unit that compares the first image data stored in the memory unit with the second image data for each pixel and that writes the second image data to the memory unit for each pixel to update the first image data stored in the memory unit when both sets of image data are not matched with each other.

11. The display device according to claim 1, further comprising:
a color reducing unit that performs a color reducing process on data sent from a host depending on gray scales of pixels which can be expressed by the display panel to create the first image data and the second image data.

12. An electronic apparatus comprising a display device including:
an update area detecting unit that detects a rewritten area on the basis of first image data previously transmitted and second image data newly transmitted and that sends out only a part of the second image data in the rewritten area to a display panel which includes a memory that stores image data or a cell having a memory effect in each pixel.
